(19) United States
(12) Patent Application Publication
(10) Pub. No.: US 2023/0186404 A1
(43) Pub. Date: Jun. 15, 2023

(54) Method and System for Classifying Financial Transactions

(71) Applicant: Formfree Holdings Corporation, Johns Creek, GA (US)

(72) Inventors: Michael Covington, Johns Creek, GA (US); Brent A. Chandler, Johns Creek, GA (US); Brian Francis, Johns Creek, GA (US)

(21) Appl. No.: 17/983,368

(22) Filed: Nov. 8, 2022

Related U.S. Application Data
(60) Provisional application No. 63/277,048, filed on Nov. 8, 2021.

(51) Int. Cl. G06Q 40/12

(52) U.S. Cl. CPC G06Q 40/12

(57) ABSTRACT

A method and system for classification of transactions includes obtaining or aggregating financial information (having transactions) connected with the user or customer and electronically categorizing these debit or credit transactions. The method or system can assign a category score to each or some of the transaction to categorize the transaction. The multiple scores are then narrowed to empirical or behavior rules to specifically assign the transaction to a single category of the debit.

### TECHNICAL FIELD

This application generally relates to the field of classification. More particularly, the application relates to the assessment of and classification of transaction-level financial data.

### BACKGROUND

Financial data contains fundamental information about a person and describes of the flow of money between parties. Effectively labeling and categorizing transactions at scale cannot be accomplished with human level work. At scale, the information returned from human analysis almost always contains errors and is too slow to work practically. The transactions provide insight into a person's financial health, and interpretation of these transactions has been difficult.

Accordingly, there is always a need for an improved method or system for classifying transactions.

### SUMMARY

This application discloses a method and system for classification of transactions that includes obtaining or aggregating financial information (having transactions) connected with the user or customer and electronically categorizing these debit or credit transactions using two steps or at least two steps. More particularly, the method or system can assign a category score to each or some of the transaction to categorize the transaction (e.g., into paychecks, income, groceries, utilities, loan payments, vehicle payments or others). The credit or debit data can be compared to a database that associates vendor or entities or activities with one or more categories. A category score is assigned to each category. The method or system then applies human behavioral rules or empirical to identify the specific category of the debit or credit. The system evaluates data associated with each customer and reports the same.

### BRIEF DESCRIPTION OF THE DRAWINGS

FIG. 1 is a block diagram illustrating operation of an exemplary method or system;

FIG. 2 is a block diagram illustrating an exemplary analysis for use with various methods and systems:

FIG. 3 is a block diagram illustrating the operation of an exemplary method system,

FIG. 4 is a block diagram illustrating the operation of another exemplary method or system;

FIG. 5 is a block diagram illustrating a specific example of a transaction using the exemplary method or system;

FIG. 6 shows a category score measured or determined as distance from center of a 3-dimensional cloud; and

FIG. 7 shows that the distance can be mapped into subject factors using a smooth fall-off function.

### DETAILED DESCRIPTION

This application is directed to methods and systems for analyzing and classifying financial transactions. These transactions may be structured data (e.g. transaction records from financial institutes) and unstructured data (e.g. text from documents) for a customer of an institution in order to identify and classify relevant transactions.

The system attempts to categorize each transaction into a distinct type of expenditure, such as groceries, fuel, entertainment, etc., which, depending on the purpose of the classification, may reflect different personal spending goals, different industries, or different activities. The system includes identifying and categorizing the activity likely to be associated with the transaction. The category of items may be groceries, utilities, home maintenance expenses, brokerage transactions, mortgage payments, loan payments, and others. A single transaction may actually be categorized by the system into multiple categories. The system has a method using a category and probability, which it applies in real time to specify the strength of each classification. The system then selects the best classification for each particular transaction using human behavioral rules or empirical rules. Thus, the rating and ultimate class identification indicates the likelihood that the identified industry, company, and activity are all correct.

One embodiment includes a method and system for classification of transactions that includes obtaining or aggregating financial information (having transactions) connected with the user or customer and electronically categorizing these debit or credit transactions using two steps or at least two steps. More particularly, the method or system can assign a category score to each or some of the transaction to categorize the transaction (e.g., into paychecks, income, groceries, utilities, loan payments, vehicle payments or others). The credit or debit data can be compared to a database that associates vendor or entities or activities with one or more categories. The category score is assigned each defined category. The method or system then applies human behavioral rules or empirical rules to identify the specific category of the debit or credit. The system evaluates data associated with each customer.

For illustration, the system or method can determine the activity or vendor associated with the transaction by mining available fields to determine the total list of matches with a known taxonomy of terms and then assigning a category score to each of those categories. The terms represent likely categories for a variety of industries and activities. More than one term will likely be associated with the multiple industries or activities. For example, a transaction can be associated with a grocery category purchase, pharmacy category purchase, or other category purchase, and each category can be assigned using a category score. Once the categories (within a defined universe of categories) are assigned a category score, then the system or method assigns a rating to the transactions in those categories, some of the categories will have a “zero” score. In other words, and for example, transactions may have a positive score for groceries and zero score for vehicle expenses.

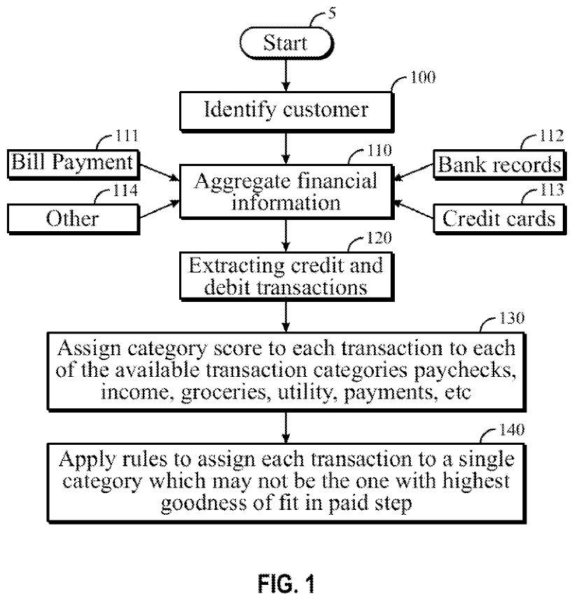

FIG. 1 shows a block diagram illustrating one embodiment beginning at start S with the identification of a customer 100. The customer may be the person who has debit and credit transactions that are gathered by the system 110 or the method. The transactions may be bill payments 111, bank records 112, credit card statements 113, and/or other materials or histories 114. Most of the records may be structured data (e.g., transaction records from financial institutes) and unstructured data (e.g. text from documents) for a customer of an institution in order to identify relevant transactions. After the debit and credit transaction are aggregated 110, the words and phrases are extracted from the transactions 120. The transactions are than assigned a category score to each of the available or defined categories 130. To provide the final single category, human behavior rules or empirical rules 140 are applied to the non-zero or higher scored categories the category score analysis 120.

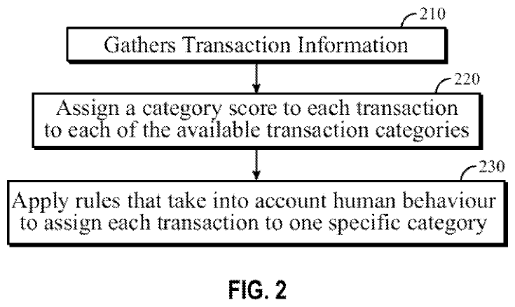

FIG. 2 shows a block diagram illustrating one embodiment beginning with transactions, with descriptions, collected from financial institutions 210. Based on its description, each transaction is rated for category score to each of a large number of categories 210. The categories are formulated and developed by the user or administrator of the system; and there may be more or less in terms of number of categories based on preferences. This is done by recognizing words and phrases in the description, e.g., “Kroger” is a grocery store. The assignment step 220 can include dictionaries or taxonomy that contain words and phrases found in descriptions. Each match to a dictionary entry assigns one or more specific category score. For instance, a database may assign “Piggly Wiggly” 100% or 1.0 to Groceries and zero to everything else, but it may assign “Kroger” 80% to Groceries and 70% to Pharmacy (they need not total 100%) because Kroger does both kinds of business. The dictionaries are built by a human expert looking at transaction descriptions and judging how they should be classified and what word, words, or phrase should be recognized. For instance, “KROGER 2367 CINCINNATI Ohio” is recognized by “KROGER”, not the whole description. During transaction classification, the process of matching descriptions to dictionary entries can include steps in which words are separated, in which irrelevant words and character strings are discarded, and in which abbreviations are recognized by partial matching. The category score for each transaction to each category is on a continuous scale, which can be 0% to 100%, 0.0 to 1.0, or any other continuous scale.

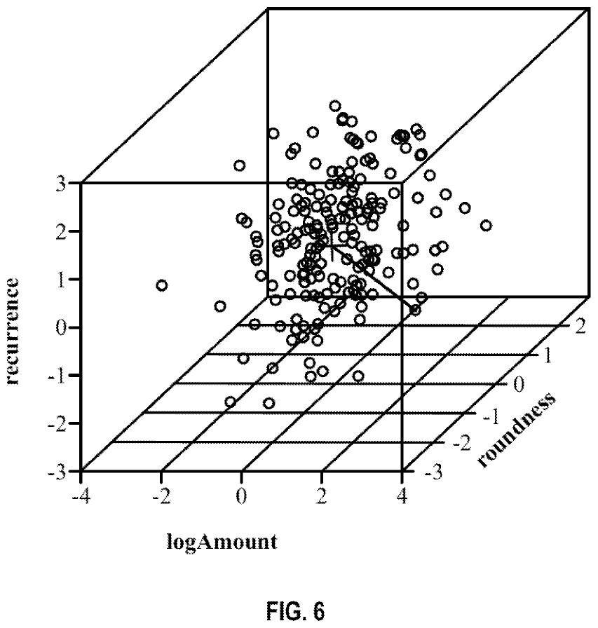

Optionally, rules can be applied that adjust the category score in each category. For example, if a transaction has nonzero (or a point substantially higher than zero) category score to both Groceries and Pharmacy, and its characteristics match a grocery transaction better than a pharmacy transaction, the category score to Groceries can be increased, and the category score to Pharmacy can be reduced. Characteristics include size of the transaction in dollars, roundness (e.g., $2,500 is rounder than $2,346, and this is an indication that the latter is more likely to be a special purchase, since grocery payments are seldom round). Recurrence at weekly, biweekly, or monthly intervals. This can be a matter of degree, with its own category score; duplication of the previous transaction or exactly hitting the predicted dates may be taken into account and judgement as how well a transaction fits the expectations for a recurrence of an earlier one is accounted. FIG. 6 shows an example of a 3-dimensional graph. Adjustment of category score can take into account size, roundness, and recurrence as dimensions determining distance in a 3-dimensional space. All these dimensions can be scaled nonlinearly as appropriate to give good results.

Each transaction is assigned to a single category 230. Transactions already have a category score in one or more categories, and in the simplest case, the chosen single category is the one with the best category score. Rules can apply to assign a transaction to a different category. For instance, the distinction between grocery and pharmacy transactions at Kroger could be implemented here rather than in step 3, or the work could be split across the two. In this case the rule would be, “if a transaction has nonzero category score to both Groceries and Pharmacy, and it is under $250 and has better than 0.5 category score to weekly recurrence, then it is groceries.” Rules at this stage make crisp decisions to assign a specific category, rather than just adjusting the category score. Rules at this stage can assign transaction to categories that did not exist earlier. For example, a large recurrent monthly payment might be a category to which nothing is assigned by dictionaries, but transactions are moved into it by rules.

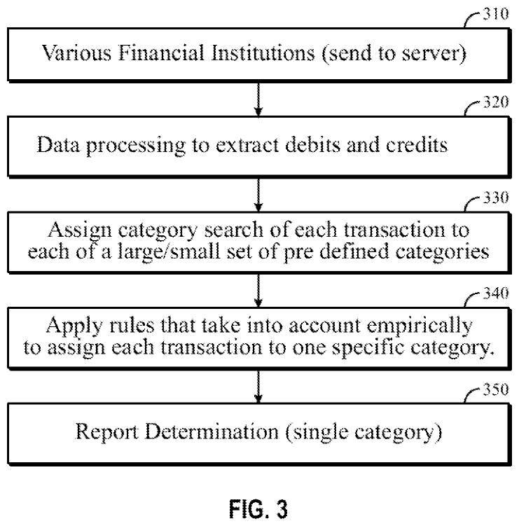

FIG. 3 shows a block diagram illustrating another embodiment. In this method or system 300, various financial institutes can send their data to server 310. Most of the records may be structured data (e.g. transaction records from financial institutes) and unstructured data (e.g. text from documents) for a customer of an institution in order to identify relevant transactions. The data is processed 320 and the words and phrases are extracted from the transactions. The transactions are than assigned a category score to each of the available or defined categories 330. To provide the final single category, human behavior rules or empirical rules 340 are applied to the non-zero or higher scored categories the category score analysis. A report with the activity associated with the single category is reported 350.

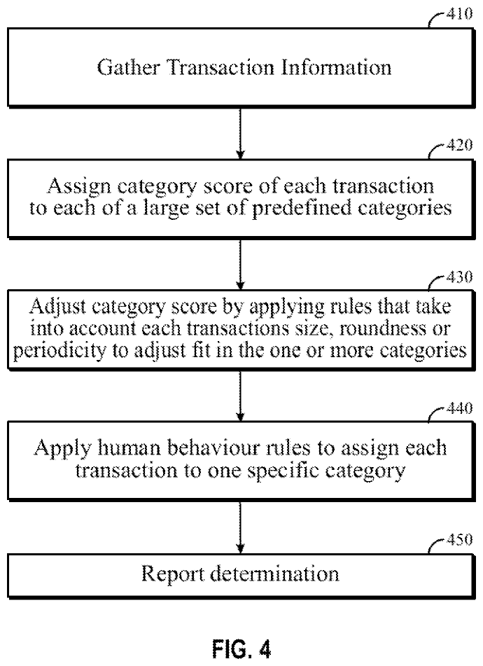

FIG. 4 shows a block diagram illustrating another embodiment. In this method or system 400, various financial institutes can send their data to server 410. Most of the records may be structured data (e.g. transaction records from financial institutes) and unstructured data (e.g. text from documents) for a customer of an institution in order to identify relevant transactions. The data is processed and the words and phrases are extracted from the transactions. The transactions are than assigned a category score to each of the available or defined categories 420. The first with each category is then adjusted using parameters such as size, roundness, and periodicity 430. To provide the final single category, human behavior rules or empirical rules 440 are applied to the non-zero or higher scored categories the category score analysis. A report with the activity associated with the single category is reported 450.

The method and system identify activity to be associated with the transaction. Exemplary activities include, but are not limited to, mortgage payments, loan payments, merchant fees, deposits, and brokerage account activity. Once an activity is identified, then the system assigns an activity rating to the transaction. Some activities are more general than others. For example, a transaction with the branded dealership might indicate the potential for a vehicle. However, if that transaction was only for $20, it is probably for accessories. However, an $10000 transaction dealership probably indicates a down payment on a vehicle. If recurring transactions occur, the transaction at issue is likely a vehicle loan. At this point each transaction has category score values to all the categories, most of them zero, but quite possibly several of them nonzero. Then: grouping of transactions that seem to have the same payee, so they can be handled collectively. Approximate matching rules can be used to tolerate slight changes in description, such as when dates or serial numbers are added.

Further and for example, a transaction with the local car dealership might indicate the potential for a car loan. However, if that transaction was only for $150, it is probably a simple repair or retail purchase. However, an $800 transaction with a vehicle finance company might indicate the presence of a car loan. If similar transactions are identified that occur each month, then the probability that this transaction is for a car loan increases. Furthermore, that transaction occurring within the same ten-day period of the month for multiple months in a row would provide even further validation that the transaction is for a car loan.

The methodology can use a rule-based system incorporating human knowledge to put each transaction into the right category, generally the one to which it has highest goodness-of-fit, but not always. Here “category score” refers to any quantitative measure of how typical a transaction is of other transactions in its category; no specific statistical assumptions are implied. At the step where the transaction has a fit to multiple transaction types, adjustment can be performed by hand-crafted rules based on experience (“if not recurrent monthly, not a car payment”) or by a more general mathematical model that compares the size, roundness, and/or regularity of each transaction to those that are typical for each category, taking into account variance as well as normal or average values, and systematically raises or lowers the category score based on the quality of the match. For example, $25,000 to Kroger is statistically a very unusual grocery payment and should have its category score to Groceries lowered. For example, at this later step where each transaction is being put into one category, human reviewers craft the rules based on transactions that they have seen being misclassified or given implausible classifications.

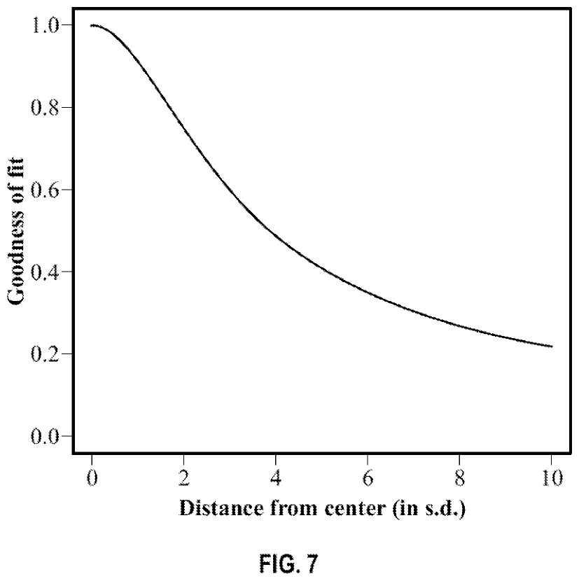

One method of adjusting a category score is as follows:
take a large collection of transactions and determine the mean and standard deviation of (1) the logarithm of the dollar amount, (2) the recurrence (1 if it recurs weekly, biweekly, or monthly, 0 if it does not, and optionally, intermediate values if the recurrence is in some way imperfect), and (3) the roundness (on a scale where numbers divisible by 100 have roundness 1.0 and other have roundness 0.0, or a more elaborate scale serving the same purpose and recognizing more degrees of roundness).
Convert these three quantities into Z-scores (mean divided by standard deviation), treat them as distances in 3 dimensions, and compute the Euclidean distance from the center. FIG. 6 is the result of the same.
Scale the distance in such a way that distance 0 maps onto 1.0 and larger distances map onto smaller numbers down to 0 or almost to 0, using a function like the one graphed in FIG. 7, which uses the formula sqrt(5/(x\hat{ }+5)). This formula was chosen to be compatible with the decisions our dictionary makers had made when assigning intermediate category scores manually.
multiply the scaling factor by the category score. For instance, if a transaction comes out with a Euclidean distance of 3 units from the center (the 3-dimensional equivalent to being 3 standard deviations away from the average), then it is substantially abnormal for that category and should have its category score cut substantially.
The second formula in the previous paragraph can be used, 3 maps onto 0.6, and the category score is multiplied by 0.6, making it much more easily overruled by higher category scores that the transaction may have in other categories.

In one embodiment, the analysis of borrowers' financial habits can identify types of transactions (e.g., utility payments, rent payments, grocery expenses, entertainment, etc.). In one example, identification of rent payments can be particularly of interest right. Some of them can be identified as “rent” because the landlord's name is recognized (e.g., a big development company) or because the payment is somehow labeled as rent. But most are recognizable only as regular monthly payments—which is much better than nothing. A lender would rather look at regular monthly payments and decide if they are rent, than look through a jumble of unsorted transactions.

As used in this application, the term “category score” means a number indicating how well a transaction fits into a particular category (e.g., how well a particular transaction at Kroger fits the category “Groceries”). While category scores can range from 0 to 1, any scale can be used with the systems and methods. In the simplest case, dictionaries assign category scores of 0 or 1. For example, the grocery dictionary may include an entry that says that any description containing the substring “PIGGLY WIGGLY” is a perfect match, scored 1. Any transaction matched to anything not in the grocery dictionary will get 0 for category Groceries.

At the discretion of the implementor, intermediate values for category scores can also be used. For example, the Groceries dictionary might assign a category score of 0.8 to descriptions containing “KROGER”, and the Fuel dictionary might assign 1.0 to descriptions containing “KROGER FUEL”. Then a transaction that says “KROGER FUEL 0356 TOLEDO Ohio” would get category scores of 0.8 for Groceries, 1.0 for Fuel, and 0 for all other categories, assuming it does not match anything in any of those categories' dictionaries. In a subsequent step, Fuel would be chosen as the single category for which this transaction has the highest category score.

Category scores can be adjusted mathematically. For instance, such scores can be systematically reduced when a transaction's size (amount in dollars), roundness, and/or regularity (recurrence) are far from the average for transactions in that category. For example, a $25,000 single transaction at Kroger is far from the average size, roundness, and recurrence of grocery transactions, and its category score for Groceries would therefore be adjusted downward. Category score in this exposition refers to any numerical measure of how closely something matches or resembles something else. It need not be a probability or any standard statistical test. More commonly, it represents a human judgment, or a value chosen empirically to obtain classifications that work well for the intended purpose. Category score need not be on a scale of 0 to 1, although it is in our examples.

A “empirical rules” can mean stated conditions either for changing a category score or for placing a transaction into a single category (after giving it a category score to each of all the categories). These rules can be created from human knowledge and adjusted to produce empirically correct results. For instance, a rule might say that a payment to an automobile dealer that is under $100 and does not recur monthly is not a car loan payment. Rules of this type come into existence when a human being, developing the software and/or the dictionaries, sees the need for them, examines examples, and constructs a rule that will produce more accurate results than if the rule were not there. These rules can be obtained or developed to improved prediction and categorization.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; knowledge corpus; stored audio recordings; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C#, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. In some embodiments, the server may store audio recordings, transcriptions, generated utterance vectors, and dynamically trained machine learning models.

Cloud servers are examples.

In some embodiments, as detailed herein, one or more of exemplary inventive computer-based systems/platforms, exemplary inventive computer-based devices, and/or exemplary inventive computer-based components of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a social media post, a map, an entire application (e.g., a calculator), etc. In some embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) FreeBSD™, NetBSD™, OpenBSD™; (2) Linux™; (3) Microsoft Windows™; (4) OS X (MacOS)™; (5) MacOS 11 ™; (6) Solaris™; (7) Android™; (8) iOS™; (9) Embedded Linux™; (10) Tizen™; (11) WebOS™; (12) IBM i™; (13) IBM AIX™; (14) Binary Runtime Environment for Wireless (BREW)™; (15) Cocoa (API)™; (16) Cocoa Touch™; (17) Java Platforms™; (18) JavaFX™; (19) JavaFX Mobile; ™ (20) Microsoft DirectX™; (21) .NET Framework™; (22) Silverlight™; (23) Open Web Platform™; (24) Oracle Database™; (25) Qt™; (26) Eclipse Rich Client Platform™; (27) SAP NetWeaver™; (28) Smartface™; and/or (29) Windows Runtime™.

In some embodiments, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device. In at least one embodiment, the exemplary ASR system of the present disclosure, utilizing at least one machine-learning model described herein, may be referred to as exemplary software.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

In some embodiments, exemplary inventive computer-based systems/platforms, exemplary inventive computer-based devices, and/or exemplary inventive computer-based components of the present disclosure may be configured to be utilized in various applications which may include, but not limited to, the exemplary ASR system of the present disclosure, utilizing at least one machine-learning model described herein, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

In some embodiments, the exemplary inventive computer-based systems/platforms, the exemplary inventive computer-based devices, and/or the exemplary inventive computer-based components of the present disclosure may be configured to securely store and/or transmit data (e.g., speech transcription files, tokenized vectors, etc.) by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTRO, SHA-1, SHA-2, Tiger (TTH), WHIRLPOOL, RNGs).

The aforementioned examples are, of course, illustrative and not restrictive.

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

### Example

### Example 1—General

The transaction is assigned a category score to the transaction to each of a defined number of categories. The transaction has a fit in a highest scored category, a lowest scored category and various scores in between. In this example, the transaction is matched against a database of predefined categories that may be related to spending habits of people and the category score analysis determines transaction fit in each of the one or more categories. In one model, this step can assign an initial goodness-of-fit of a transaction to a category, usually 1.0 for a match and 0.0 otherwise in each of the defined categories. At this point, the transaction is rated in all of the defined categories.

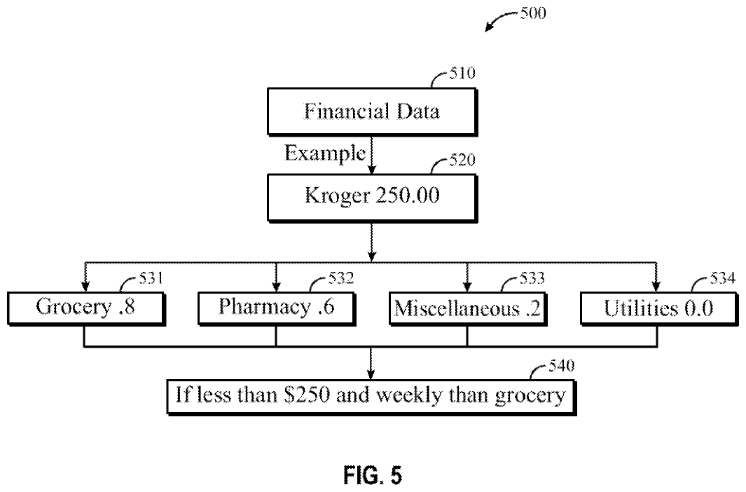

For example, as shown in FIG. 5. a transaction from the financial data 510 containing phrase KROGER 520 is matched against an array of predetermined categories (e.g., grocery 531, utilities 534, housing, insurance, medical/pharmacy 532, recreational, or miscellaneous 533). The database includes categorization of traditional business and places. The term “KROGER” may be connected to multiple categories of spending or income. A category score analysis or modeling will correlate the category with the expense. In this example, the fit ranges from 0.0 to 0.8. While not shown, the transaction can be further honed into categories using its size, its roundness, and its periodicity. In other words, if the transaction is round/not round (e.g., $250 without change is less likely to be a grocery item), then the transaction more or less likely to be in the defined category.

The next step is selecting the category that transaction fit therein using human defined rules. At this point each transaction has goodness-of-fit values to all the categories, most of them zero, but quite possibly several of them nonzero. The mid or higher values can be analyzed using rules from human behavior or empirical findings. A rule-based system incorporates human knowledge to put each transaction into the right category, generally the one to which it has highest goodness-of-fit, but not always. Other criteria including the size of the transaction or the periodicity of the transaction can further help characterize the fit of the transaction into one or more categories. For example, a $250 charge at a grocery store is less likely to be a routine grocery charge and more likely to be a special event. 540 Here is an exemplary part of the rule-based system in exemplary code:

```
      if  (g.MeanValueOfTag(“d_StudentLoanPayment”)  > 0.5) return
groupType.EXPENSES__Student_LoanPayments;
      if (g.MeanValueOfTag(“d_PaycheckAdvanceRepayment”) > 0.5)
  return GroupType.EXPENSES__Paycheck_Advance_Loan_Repayments;
      if (g.MeanValueOfTag(“d_AutomobilePayment”) > 0.5 &&
g.MeanValueOfTag(“d_AutomobilePayment”) > 0.9 * g.MeanValueOfTag(“d_Automotive”))
      // Auto repairs, etc., may look very much like car payments, so the values of the two tags
can be compared.
if goodness_of_fit(StudentLoanPayment) > 0.5:
      category = StudentLoanPayment
elif goodness_of_fit(PaycheckLoanPayment):
      category = PaycheckLoanPayment
elif goodness_of_fit(AutomobilePayment) > 0.5:
      if amount < 100.00 or monthly_recurrence < 0.5:
            category = AutomobileAccessoriesAndService
      else
            category = AutomobilePayment
```

In another example and to illustrate the code above, student loan payments and paycheck loan payments are recognized merely by having sufficiently high category score to their categories, but things that look like automobile payments may be accessories and service if the amount is small or lacks monthly recurrence.

### Example 2—Honing the Categories

The categories can be honed using the using the following methodology:
Know the mean and standard deviation of log amount, roundness, and recurrence measures for transactions in the class;
In each of those 3 dimensions, measure the distance of a particular transaction, in standard deviations, from the mean;
Convert the overall Euclidean distance to a goodness-of-fit measure.

This picture explains the concept of measuring distance from the center (the mean) in 3 dimensions. FIG. 6 shows that the distance can be mapped into subject factors using a smooth fall-off function. By using subject human behavior rules, more consistent and/or accurate characterization of the debit or credit may be obtained. The distance is an indicator of typicality and not a statistical measure of probability.

### Example 3—Tagging for Roundness, Recurrence, and Size

The first step in one method of processing transactions begins by labeling (tagging) each transaction with measures of its size (actually using the logarithm of the amount, since amounts of money are lognormally distributed, and proportional differences between them are more informative than absolute differences); roundness (e.g., 2,500 is a more round number than 2,483, and a technique has been developed to map roundness onto a scale of 0 to 1); and recurrence across weekly, biweekly, or monthly intervals (again, this is characterized as a matter of degree, depending on how many transactions are in a sequence and how closely each of them matches the previous transaction and the expected number of days in between).

### Example 4—Dictionary Description Tagging

The next step is to search the description of each transaction (e.g., “KROGER FUEL 2350 CINCINNATI Ohio 555-2345”) for words, phrases, and other character strings that indicate the nature of the transactions. This is done with the aid of a set of dictionaries. In this example, KROGER matches the Groceries dictionary, which assigns it a specific initial goodness-of-fit of 0.8 (because the dictionary reflects the fact that Kroger can also be other things), and KROGER FUEL matches the AutomobileFuel dictionary with a category score of 1.0 because the dictionary encodes the knowledge that it cannot be anything else. Through such a process, each transaction is assigned a category score to each category, which is 0 if nothing in the appropriate dictionary matches it, or if, as sometimes happens, a dictionary encodes that a business is definitely not of a particular type. For instance, a tavern named TOLEDO BOWLING ALLEY, known to go by that name, might be in the sports dictionary with a category score of 0.0 so that the phrase BOWLING ALLEY does not lead to its being tagged as a sports venue. Dictionaries use exact matching of substrings and also matching to regular expressions.

### Example 5—Statistical Adjustment

A statistical adjustment step can be performed after dictionary tagging, before placing transactions by rule into single categories. The statistical adjustment step after and lowers the goodness-of-fit values (which are mostly initially 1.0 when a match was made, though dictionaries can specify a lower initial value) if, and to the extent that, the transactions are atypical for their classes. Here, for example, is the place where a $25,000 transaction at Kroger would have its category score to Groceries lowered because the amount is extraordinarily large, round, and non-recurrent.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A method, comprising:
receiving, by a financial system comprising one or more computers, customer data associated with a customer of a financial institution, the customer data comprising at least one of (i) financial transaction data associated with the customer, or (ii) financial account data associated with the customer;
extracting text-based information from the financial transaction data that includes information related to amounts, dates, and parties for the financial transaction data,
assigning a category score to transaction within the financial transaction data to each of a defined number of categories, wherein the category score has a fit in a highest scored category and a lowest scored category;
applying rules to assign the transaction to an assigned category.

2. The method of claim 1, wherein the assigned category is not the highest scored category.

3. The method of claim 1, further comprising preparing a report on the transactions.

4. The method of claim 1, wherein the transaction description is matched against a database of a category.

5. The method of claim 1, further comprising rating each category based on size, roundness, and regularity of each transaction.
